(19) United States
(12) Patent Application Publication
(10) Pub. No.: US 2020/0231146 A1
(43) Pub. Date: Jul. 23, 2020

(54) DRIVING ASSISTANCE APPARATUS

(71) Applicant: Toyota Jidosha Kabushiki Kaisha, Toyota-shi Aichi-ken (JP)

(72) Inventors: Kumiko Miyano, Susono-shi (JP); Miyuki Kamatani, Susono-shi (JP); Wataru Sasagawa, Susono-shi (JP); Takahisa Awata, Susono-shi (JP)

(73) Assignee: Toyota Jidosha Kabushiki Kaisha, Toyota-shi Aichi-ken (JP)

(21) Appl. No.: 16/743,722

(22) Filed: Jan. 15, 2020

(30) Foreign Application Priority Data
Jan. 17, 2019 (JP) 2019-005936

(51) Int. Cl. B60W 30/09

(52) U.S. Cl. CPC B60W 30/09; B60W 2710/20; B60W 2720/10; B60W 2554/20

(57) ABSTRACT

A driving assistance apparatus includes: an executor configured to perform at least one of a deceleration control and a steering control of a host vehicle, as an avoidance assistance control; a first determinator configured to determine whether or not the target is a vehicle; a second determinator configured to determine whether the target is a stopped vehicle, which has a possibility to move before the host vehicle passes it, or parked vehicle, which does not have a possibility to move before the host vehicle passes it, if it is determined by the first determinator that the target is a vehicle; and a controller programmed to control the executor to change a control aspect of the avoidance assistance control between if it is determined by the second determinator that the target is the stopped vehicle and if it is determined by the second determinator that the target is the parked vehicle.

### CROSS-REFERENCE TO RELATED APPLICATIONS

This application is based upon and claims the bone fit of priority of the prior Japanese Patent Application No. 2019-005936. filed on Jan. 17, 2019, the entire contents of which are incorporated herein by reference.

### BACKGROUND

### 1. Technical Field

Embodiments of the present disclosure relate to a driving assistance apparatus configured to preside driving assistance for a vehicle.

### 2. Description of the Related Art

For this type of apparatus, there is known an apparatus configured to perform a control for avoiding a collision between a vehicle and an avoidance target, which is ahead of the vehicle (hereinafter referred to as an “avoidance assistance control” as occasion demands) For example, Japanese Patent Application Laid Open No. 2017-206039 (Patent Literature 1) discloses a technology/technique of performing a deceleration control and a steering control of a host vehicle if a vehicle ahead is in a predetermined assistance range.

A need for the avoidance assistance control (e.g., a possibility of a collision between the host vehicle and the avoidance target) varies depending on in which state the avoidance target is put Specifically, the need for the avoidance assistance control is significantly different between if another vehicle that is the avoidance target is a vehicle that has a possibility to quickly move (e.g., a vehicle that is temporarily stopped at a traffic light or the like) and if the other vehicle is a vehicle that does not have a possibility to quickly move (e.g., a vehicle from which a driver is away), even if a relative position relation between the host vehicle and the other vehicle is the same in the both cases.

In the technology/technique described in the Patent Literature 1, however, the state of the avoidance target, (e.g., in which timing the avoidance target starts to move) is not considered at all. It is thus hardly possible to perform an appropriate avoidance assistance control corresponding to situations, which is technically problematic.

### SUMMARY

In view of the problem described above, it is therefore an object of embodiments of the present disclosure to provide a driving assistance apparatus configured to perform an appropriate avoidance assistance control in accordance with a state of another vehicle.

An aspect of a driving assistance apparatus according to the present disclosure is provided with: an executor configured to perform at least one of a deceleration control and a steering control of a host vehicle, as an avoidance assistance control for avoiding a contact between the host vehicle and a target, which is ahead of the host vehicle; a first determinator configured to determine whether or not the target is a vehicle; a second determinator configured to determine whether the target is (i) a stopped vehicle, which has a possibility to move before the host vehicle passes it, or (ii) a parked vehicle, which does not have a possibility to move before the host vehicle passes it, if it is determined by the first determinator that the target is a vehicle; and a controller programmed to control the executor such that a control aspect of the avoidance assistance control is different between if it is determined by the second determinator that the target is the stopped vehicle and if it is determined by the second determinator that the target is the parked vehicle.

### BRIEF DESCRIPTION OF THE DRAWINGS

FIG. 1 is a block diagram illustrating a configuration of a vehicle according to an embodiment;

FIG. 2 is a plan view illustrating an example of an avoidance assistance control for a parked vehicle;

FIG. 3 is a plan view illustrating an example of an avoidance assistance control for a stopped vehicle;

FIG. 4 is a flowchart illustrating a flow of operations of a driving assistance apparatus according to the embodiment;

FIG. 5 is version 1 of a table illustrating an example of control aspects of the avoidance assistance control performed by the driving assistance apparatus according to the embodiment; and

FIG. 6 is version 2 of the table illustrating an example of the control aspects of the avoidance assistance control performed by the driving assistance apparatus according to the embodiment.

### DETAILED DESCRIPTION OF THE EMBODIMENT

Hereinafter, a driving assistance apparatus according to an embodiment of the present disclosure will be explained with reference to the drawings.

<Configuration of Apparatus>

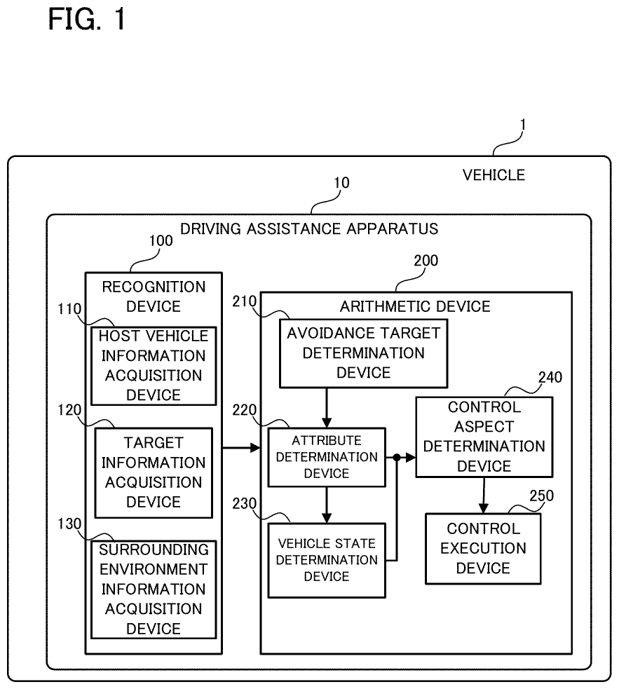

Firstly, a configuration of a driving assistance apparatus according to the embodiment will be explained with reference to FIG. 1. FIG. 1 is a block diagram illustrating a configuration of a vehicle according to the embodiment.

As illustrated in FIG. 1, a driving assistance apparatus 10 according to the embodiment is mounted on a vehicle 1 and is configured to perform an assistance control for assisting in driving the vehicle 1 (which is specifically an avoidance assistance control for avoiding a collision between the vehicle 1 and an avoidance target). The driving assistance apparatus 10 may be configured, for example, as an electronic control unit (ECU) mounted on the vehicle 1, and is provided with a recognition device 100 and an arithmetic device 200, as logical processing blocks or physical processing circuits to realize functions thereof.

The recognition device 100 is configured to recognize (or, in other words, obtain) various information to be used for the avoidance assistance control. The recognition device 100 is provided with a host vehicle information acquisition device 110, a target information acquisition device 120, and a surrounding environment information acquisition device 130.

The host vehicle information acquisition device 110 is configured to obtain information about the vehicle 1 (hereinafter referred to as “host vehicle information” as occasion demands), which is detected, for example, by a vehicle speed sensor, an acceleration sensor, a yaw rate sensor, a steering sensor or the like. The target information acquisition device 120 is configured to obtain information about a target that can be an avoidance target around the vehicle 1 (e.g., another vehicle, a pedestrian, a bicycle, etc.) (hereinafter referred to as “target information” as occasion demands), which is detected, for example, by an in-vehicle camera, a radar, light detection and ranging (LIDAR), or the like. The surrounding environment information acquisition device 130 is configured to obtain information about a surrounding environment (e.g., a white line, etc.) (hereinafter referred to as “surrounding environment information” as occasion demands), which is detected, for example, by an in-vehicle camera, a radar, LIDAR, or the like. Each of the information obtained by the host vehicle information acquisition device 110, the target information acquisition device 120, and the surrounding environment information acquisition device 130 may be outputted to the arithmetic device 200. A detailed explanation of a more specific method of obtaining each information on the host vehicle information acquisition device 110, the target information acquisition device 120, and the surrounding environment information acquisition device 130 will be omitted herein because the existing technologies/techniques can be applied, as occasion demands.

The arithmetic device 200 is configured to perform an arithmetic operation by using the information obtained by the recognition device 100 and is configured to enable the vehicle 1 (hereinafter referred to as a “host vehicle 1” as occasion demands) to perform the avoidance assistance control. The arithmetic device 200 is provided with an avoidance target determination device 210, an attribute determination device 220, a vehicle state determination device 230, a control aspect determination device 240, and a control execution device 250.

The avoidance target determination device 210 is configured to determine whether or not there is an avoidance target, on which the avoidance assistance control is to be performed, around the vehicle, by using the target information obtained by the target information acquisition device 120. A detailed explanation of a determination method for the avoidance target will be omitted herein because the existing technologies/techniques can be applied, as occasion demands. A determination result of the avoidance target determination device 210 may be outputted to the attribute determination device 220.

The attribute determination device 220 is configured to determine an attribute (or in other words, a type) of the avoidance target, by using the target information obtained by the target information acquisition device 120. The attribute determination device 220 according to the embodiment is particularly configured to determine whether or not the avoidance target is a vehicle, wherein the “vehicle” herein does not include a bicycle. A specific determination method performed by the attribute determination device 220 will be detailed later. A determination result, of the attribute determination device 220 may be outputted to each of the vehicle state determination device 230 and the control aspect determination device 240. The attribute determination device 220 is a specific example of the “first determinator” in Supplementary Notes described later.

The vehicle state determination device 230 is configured to determine in which state the avoidance target determined to be a vehicle by the attribute determination device 220 is put, by using the target information obtained by the target information acquisition device 120. More specifically, the vehicle state determination device 230 is configured to determine whether the avoidance target that is a vehicle is a “stopped vehicle”, which has a possibility to move before the host vehicle 1 passes it, or a “parked vehicle”, which does not have a possibility to move before the host vehicle 1 passes it. A specific determination method performed by the vehicle state determination device 230 will be detailed later. A determination result of the vehicle state determination device 230 may be outputted to the control aspect, determination device 240. The vehicle state determination device 230 is a specific example of the “second determinator” in Supplementary Notes described later.

The “parked vehicle” according to the embodiment, as described above, may mean a vehicle as the avoidance target that does not have a possibility to move before the host vehicle 1 passes it. In other words, please note that the vehicle as the avoidance target that does not have a possibility to move before the host vehicle 1 passes it, may be treated as the “parked vehicle” in the embodiment, even if it corresponds to the “stopped vehicle” in general (e.g., under Road Traffic Act). In the same manner, the “stopped vehicle” according to the embodiment, as described above, may mean a vehicle as the avoidance target that has a possibility to move before the host vehicle 1 passes it. In other words, please note that the vehicle as the avoidance target that has a possibility to move before the host vehicle 1 passes it, may be treated as the “parked vehicle” in the embodiment, even if it corresponds to the “parked vehicle” in general.

The control aspect determination device 240 is configured to determine a control aspect of the avoidance assistance control (e.g., an assistance amount of the avoidance assistance control, start timing, etc.) on the basis of the attribute of the avoidance target determined by the attribute determination device 220 and the state of the avoidance target determined by the vehicle state determination device 230. A specific method of determining the control aspect performed by the control aspect determination device 240 will be detailed later. Information about the control aspect determined by the control aspect determination device 240 may be outputted to the control execution device 250. The control aspect determination device 240 is a specific example of the “controller” in Supplementary Notes described later.

The control execution device 250 is configured to perform the avoidance assistance control (which is specifically at least one of a steering control and a deceleration control), by controlling the operation of each part or device of the vehicle 1, on the basis of the control content or aspect determined by the control aspect determination device 240. In other words, the operation of the control execution device 250 may be controlled by the control aspect determination device 240. The control execution device 250 may perform the avoidance assistance control, for example, by controlling operations of a brake actuator, a steering actuator, and the like of the host vehicle 1, which are not illustrated. A condition that allows the avoidance assistance control to be performed, may include, for example, a situation in which it can be determined that there is a high possibility of a contact with the avoidance target if the host vehicle 1 goes straight (i.e., a situation in which a lateral distance between the host vehicle 1 and the avoidance target is less than or equal to a predetermined value). The control execution device 250 is a specific example of the “executor” in Supplementary Notes described later.

<Technical Problem>

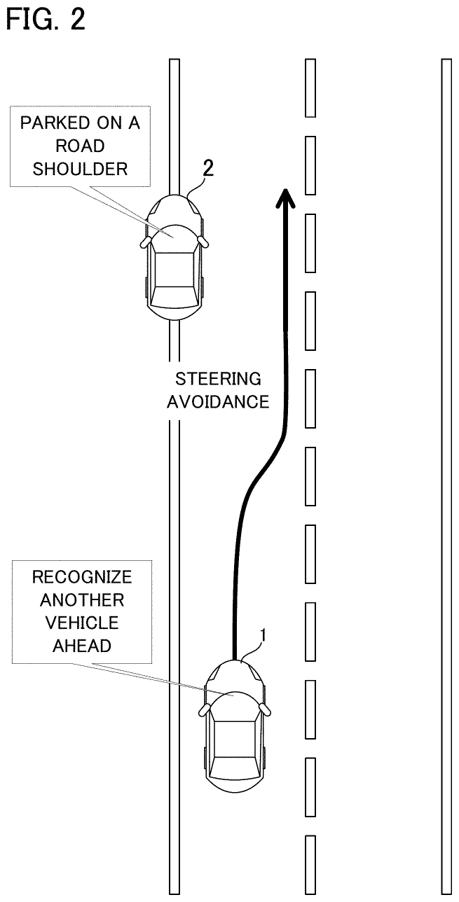

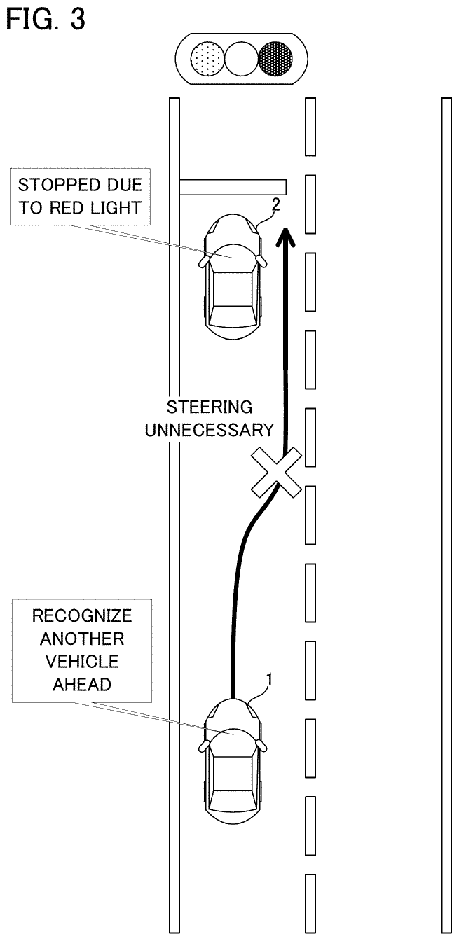

Next, with reference to FIG. 2 and FIG. 3, an explanation will be given to a technical problem that can occur during execution of the avoidance assistance control. FIG. 2 is a plan view illustrating an example of the avoidance assistance control for the parked vehicle. FIG. 3 is a plan view illustrating an example of the avoidance assistance control for the stopped vehicle.

As illustrated in FIG. 2, suppose that another vehicle 2 is detected as the avoidance target, ahead of the host vehicle 1 in a direction of travel. The other vehicle 2 herein may be the “parked vehicle”, which is parked on a road shoulder (i.e., the vehicle that does not have a possibility to move before the host vehicle 1 passes it). In this case, on the host vehicle 1, the avoidance assistance control for avoiding a collision with the other vehicle 2 may be performed. Specifically, the steering control may be performed such that a lateral distance between the host vehicle 1 and the other vehicle 2 is greater than a predetermined distance (e g., a distance set to pass by the other vehicle 2) (refer to a thick solid line in FIG. 2). Moreover, if necessary, the deceleration control of the host vehicle 1 may be also performed together.

On the other hand, as illustrated in FIG. 3, if the other vehicle 2 is the “stopped vehicle” (i.e., the vehicle that has a possibility to move before the host vehicle 1 passes it), the avoidance assistance control for avoiding a collision with the other vehicle 2 is considered to be unnecessary. Specifically, as in an example illustrated in FIG. 3, if the other vehicle 2 is temporarily stopped at a red light, the host vehicle 1 does not have to pass the other vehicle 2, and it may be sufficient to stop behind the other vehicle 2. In other words, it is not necessary to perform the steering control and the deceleration control, which is performed together with the steering control. A deceleration control for stopping behind the other vehicle 2 (i.e., a deceleration control different from the avoidance assistance control), however, may be performed. Alternatively, if the traffic light is changed to green at an early stage and the other vehicle 2 starts to move, the host vehicle 1 does not even need to decelerate.

As described above, if there is the other vehicle 2 as the avoidance target ahead of the vehicle 1, the control aspect of the avoidance assistance control should be changed depending on the state of the other vehicle 2. However, if it is not clear in which state the other vehicle 2 is put (i.e., if it cannot be determined whether the other vehicle 2 is the “parked vehicle” or the “stopped vehicle”), it is hardly possible to accurately determine the need for the avoidance assistance control. For example, if the avoidance assistance control is performed in the situation as in FIG. 3, an occupant of the host vehicle 1 may feel troublesome. The driving assistance apparatus 10 according to the embodiment may perform operations explained below to solve such a technical problem.

<Explanation of Operation>

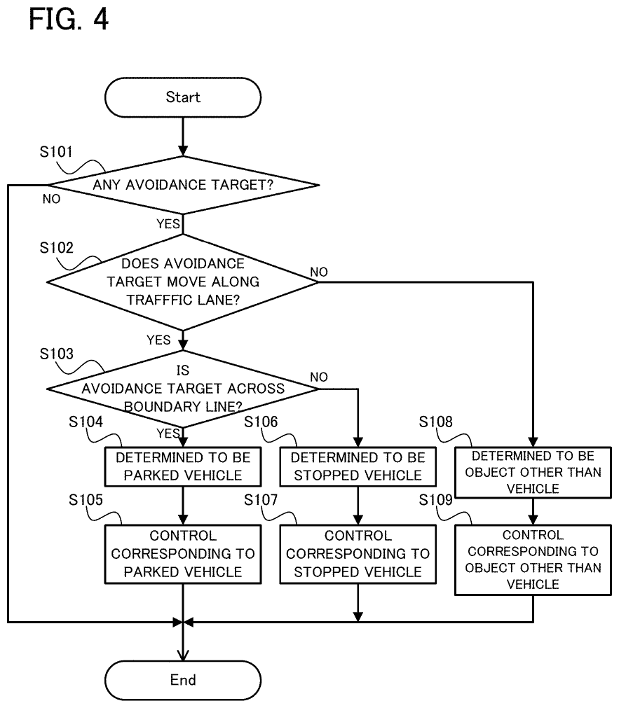

Next, a flow of operations of the driving assistance apparatus 10 according to the embodiment will be explained with reference to FIG. 4. FIG. 4 is a flowchart illustrating the flow of operations of the driving assistance apparatus according to the embodiment.

As illustrated in FIG. 4. in operation of the driving assistance apparatus 10 in the embodiment, the avoidance target determination device 210 firstly determines whether or not there is an avoidance target ahead of the host vehicle 1 (step S101). If it is determined that there is no avoidance target (the step S101: NO), the subsequent process is omitted and a series of steps is ended. In this case, the driving assistance apparatus 10 may start the step S101 again after a lapse of a predetermined period. In the embodiment, a running vehicle, which is another vehicle that travels ahead of the vehicle 1, may not be treated as the avoidance target.

If it is determined that there is an avoidance target (the step S101; YES), the attribute determination device 220 determines whether or not the avoidance target moves along a traffic lane (step S102). Whether or not the avoidance target moves along a traffic lane can be determined by a direction of the avoidance target, a movement before it stops (i.e., past behavior), or the like. The step S102 is a step for determining whether or not the avoidance target is a vehicle. The avoidance target that is a vehicle moves along a traffic lane, but the avoidance target that is not a vehicle (e.g., a pedestrian, a bicycle, etc.) does not move along a traffic lane (e.g., it moves to cross the traffic lane). It is thus possible to easily and accurately determine whether or not the avoidance target is a vehicle in the aforementioned manner. This determination method, however, is merely an example, and another method may be also used to determine whether or not the avoidance target is a vehicle.

If it is determined that the avoidance target moves along a traffic lane (the step S102 YES), the attribute determination device 220 determines that, the avoidance target is a vehicle. The vehicle state determination device 230 then determines whether or not the vehicle as the avoidance target is across a boundary line of a roadway (e.g., a white line, a curbstone, a stepped sidewalk, a road shoulder, etc.) (step S103). A detailed explanation of a specific method of detecting the boundary line of a roadway or the like will be omitted herein because the existing technologies/techniques can be applied, as occasion demands. The step S103 is a step for determining whether the vehicle as the avoidance target is the “parked vehicle” or the “stopped vehicle”. According to studies by the present inventors, it is found that the parked vehicle tends to stop across the boundary line of a roadway, whereas the stopped vehicle tends to stop without crossing the boundary line of a roadway. It is thus possible to easily and accurately determine whether or not the avoidance target is the parked vehicle or the stopped vehicle. This determination method, however, is merely an example. For example, the determination can be also made in accordance with a lateral distance between the avoidance target, and a roadway boundary (i.e., a distance in a vehicle width direction). Another method may be also used to determine whether or not the avoidance target is the parked vehicle or the stopped vehicle.

If it is determined t hat the vehicle as the avoidance target is across the boundary line of a roadway (the step S103: YES), it is determined that the avoidance target is the “parked vehicle” (step S104). In this case, the control aspect determination device 240 determines the control aspect of the avoidance assistance control to be an aspect corresponding to the parked vehicle (which will be detailed later), and the control execution device 250 controls each part or device of the host vehicle 1 to perform the avoidance assistance control corresponding to the parked vehicle (step S105).

On the other hand, if it is determined that the vehicle as the avoidance target is not across the boundary line of a roadway (the step S103: NO), it is determined that the avoidance target is the “stopped vehicle” (step S106). In this case, the control aspect determination device 240 determines the control aspect of the avoidance assistance control to be an aspect corresponding to the stopped vehicle (which will be detailed later), and the control execution device 250 controls each part or device of the host vehicle 1 to perform the avoidance assistance control corresponding to the stopped vehicle (stop S107).

On the other hand, if it is determined that the avoidance target does not move along a traffic lane (the step S102: NO), the attribute determination device 220 determines that the avoidance target is an “object other than a vehicle” (step S108). In this case, the control aspect determination device 240 determines the control aspect of the avoidance assistance control to be an aspect corresponding to the object other than a vehicle (which will be detailed later), and the control execution device 250 controls each part or device of the host vehicle 1 to perform the avoidance assistance control corresponding to the object other than a vehicle (step S109).

<Difference in Control Content and Technical Effect>

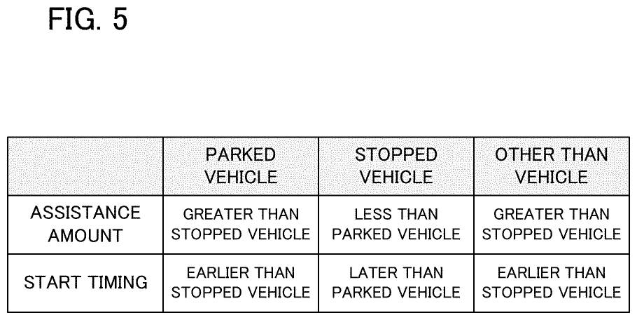

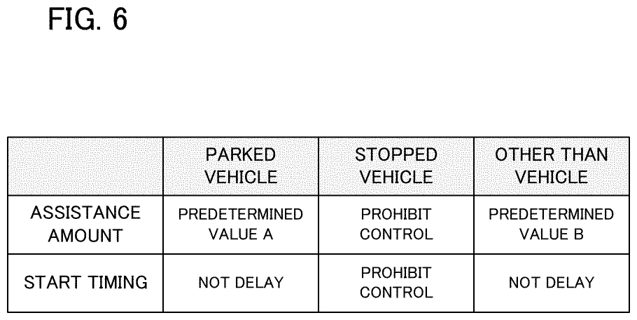

Next, with reference to FIG. 5 and FIG. 6, an explanation will be given to specific contents of the avoidance assistance control corresponding to the attribute and state of the avoidance target (i.e., a difference among the steps S105, S107, and S109 in FIG. 4) and a technical effect demonstrated by the control. FIG. 5 is version 1 of a table illustrating an example of control aspects of the avoidance assistance control performed by the driving assistance apparatus according to the embodiment. FIG. 6 is version 2 of the table illustrating an example of the control aspects of the avoidance assistance control performed by the driving assistance apparatus according to the embodiment.

As illustrated in FIG. 5, the control aspect determination device 240 may change the control aspect of the avoidance assistance control by changing at least one of an assistance amount of the avoidance assistance control and start timing. Specifically, if the avoidance target is the parked vehicle, the control aspect determination device 240 may determine the control aspect to increase the assistance amount of the avoidance assistance control (i.e., at least one of a steering amount and a deceleration amount), in comparison with those when the avoidance target is the stopped vehicle. In other words, if the avoidance target is the stopped vehicle, the control aspect determination device 240 may determine the control aspect to reduce the assistance amount, in comparison with those when the avoidance target is the parked vehicle. As explained in FIG. 2 and FIG. 3, if the avoidance target is the stopped vehicle, a need for the avoidance assistance control is lower than those when the avoidance target is the parked vehicle. It is thus possible to perform a more appropriate avoidance assistance control by changing the assistance amount, as described above.

Moreover, if the avoidance target is other than a vehicle, the control aspect determination device 240 may determine the control aspect to increase the assistance amount, in comparison with those when the avoidance target is the stopped vehicle. For the avoidance target other than a vehicle, unlike the stopped vehicle, it is not easy to predict a future movement, and reducing the assistance amount may cause such a detrimental effect that a contact cannot be avoided, it is thus possible to perform a more appropriate avoidance assistance control by changing the assistance amount, as described above.

Alternatively, if the avoidance target is the parked vehicle, the control aspect determination device 240 may determine the control aspect to advance the start timing of the avoidance assistance control, in comparison with those when the avoidance target is the stopped vehicle. In other words, if the avoidance target is the stopped vehicle, the control aspect determination device 240 may determine the control aspect to delay the start timing of the avoidance assistance control, in comparison with those when the avoidance target is the parked vehicle. As explained above, if the avoidance target is the stopped vehicle, the need for the avoidance assistance control is lower than those when the avoidance target is the parked vehicle. It is thus possible to perform a more appropriate avoidance assistance control by changing the start timing, as described above. For example, if the need for the avoidance assistance control is high, the assistance amount associated with the avoidance assistance control is also increased necessarily Here, it takes a significant time after the determination of the assistance amount until there is an actual change in the behavior of the vehicle 1 corresponding to the determined assistance amount (i.e., a mechanical response delay occurs). Thus, if the start timing of the avoidance assistance control is set to be relatively early when the need for the avoidance assistance control is relatively high, then, it is possible to steer the vehicle 1 and/or to decelerate the vehicle 1 to safely avoid the avoidance target, even if the mechanical response delay occurs. On the other hand, if the need for the avoidance assistance control is low, the assistance amount associated with the avoidance assistance control is also reduced. Thus, even if the start timing of the avoidance assistance control is set to be relatively late when the need for the avoidance assistance control is relatively low, it is possible to steer the vehicle 1 and/or to decelerate the vehicle 1 to safely avoid the avoidance target.

Moreover, if the avoidance target is other than a vehicle, the control aspect determination device 240 may determine the control aspect to advance the start timing of the avoidance assistance control, in comparison with those when the avoidance target is the stopped vehicle. For the avoidance target other than a vehicle, unlike the parked vehicle or the stopped vehicle, it is not easy to predict a future movement, and delaying the start timing may cause such a detrimental effect that a contact cannot be avoided. It is thus possible to perform a more appropriate avoidance assistance control by changing the start timing, as described above.

As illustrated in FIG. 6, the control aspect determination device 240 may set the assistance amount to a “predetermined value A” if the avoidance target is the parked vehicle, and may set the assistance amount to a “predetermined value B” if the avoidance target is other than a vehicle, whereas the control aspect determination device 240 may also prohibit the execution of the avoidance assistance control if the avoidance target is the stopped vehicle. The predetermined value A and the predetermined value B herein are greater than 0. The predetermined value A may be set in advance as the assistance amount of the avoidance assistance control corresponding to the avoidance target that is the parked vehicle, and the predetermined value B may be set in advance as the assistance amount of the avoidance assistance control corresponding to the avoidance target that is other than a vehicle. A magnitude correlation between the predetermined value A and the predetermined value B is not particularly limited. In this case, the avoidance assistance control may be performed if the avoidance target is the parked vehicle and if the avoidance target is other than a vehicle. It is thus possible to avoid a contact with the avoidance target. On the other hand, the avoidance assistance control may be prohibited if the avoidance target is the stopped vehicle. In other words, the avoidance assistance control is substantially not performed by reducing the assistance amount to zero. It is thus possible to prevent an unnecessary avoidance assistance control from being performed. It is therefore possible to perform an appropriate avoidance assistance control in accordance with the attribute and state of the avoidance target.

Alternatively, the control aspect determination device 240 may not delay the start timing if the avoidance target is the parked vehicle and if the avoidance target is other than a vehicle, whereas the control aspect determination device 240 may also prohibit the execution of the avoidance assistance control if the avoidance target is the stopped vehicle. In this case, if the avoidance target is the parked vehicle and if the avoidance target is other than a vehicle, the start timing of the avoidance assistance control may not be delayed (i.e., the avoidance assistance control is performed in normal start timing). It is thus possible to avoid a contact with the avoidance target. On the other hand, the avoidance assistance control may be prohibited if the avoidance target is the stopped vehicle. In other words, a delayed amount, is increased to the maximum, so that the avoidance assistance control is substantially not performed. It is thus possible to prevent an unnecessary avoidance assistance control from being performed. It is therefore possible to perform an appropriate avoidance assistance control in accordance with the attribute and state of the avoidance target.

<Supplementary Notes>

Various aspects of embodiments of the present disclosure derived from the embodiment explained above will be explained hereinafter.

(Supplementary Note 1)

A driving assistance apparatus described in Supplementary Note 1 is provided with: an executor configured to perform at least one of a deceleration control and a steering control of a host vehicle, as an avoidance assistance control for avoiding a contact between the host vehicle and a target, which is ahead of the host vehicle: a first determinator configured to determine whether or not the target is a vehicle, a second determinator configured to determine whether the target is (i) a stopped vehicle, which has a possibility to move before the host vehicle passes it, or (ii) a parked vehicle, which does not have a possibility to move before the host vehicle passes it, if it is determined by the first determinator that the target is a vehicle: and a controller programmed to control the executor such that a control aspect of the avoidance assistance control is different between if it is determined by the second determinator that the target is the stopped vehicle and if it is determined by the second determinator that the target is the parked vehicle.

According to the driving assistance apparatus described in Supplementary Note 1, the avoidance assistance control is performed in a different control aspect between if it is determined that the target ahead of the host vehicle is the stopped vehicle (i.e., the vehicle that has a possibility to move before the host vehicle passes it) and if it is determined that the target is the parked vehicle (i.e., the vehicle that does not have a possibility to move before the host vehicle passes it). It is thus possible to perform an appropriate avoidance assistance control corresponding to the state of the target (i.e., the avoidance target by the avoidance assistance control).

(Supplementary Note 2)

In a driving assistance apparatus described in Supplementary Note 2, if it is determined by the second determinator that the target is the stopped vehicle, the controller is programmed to control the executor to reduce an assistance amount associated with the avoidance assistance control, which is the control aspect, in comparison with those when it is determined by the second determinator that the target is the parked vehicle.

According to studies by the present inventors, it is found that the stopped vehicle has a lower need to perform the avoidance assistance control than the parked vehicle. Specifically, the stopped vehicle has a possibility to move in an aspect in which there is not a possibility to collide with the host vehicle, before the host vehicle passes it. As a result, it may be no longer necessary to perform the avoidance assistance control, or the assistance amount of the avoidance assistance control may be small. Thus, if it is determined that the target is the stopped vehicle, it is possible to perform a more appropriate avoidance assistance control by reducing the assistance amount associated with tho avoidance assistance control, in comparison with those when it is determined that the target is the parked vehicle. The expression “to reduce” herein may include a control of reducing the assistance amount to zero (i.e., a control of substantially prohibiting the avoidance assistance control).

(Supplementary Note 3)

In a driving assistance apparatus described in Supplementary Note 3, if it is determined by the second determinator that the target is the stopped vehicle, the controller is programmed to control the executor to reduce the assistance amount associated with the avoidance assistance control, in comparison with those when it is determined by the first determinator that the target is not a vehicle.

According to studies by the present inventors, it is found that the stopped vehicle has a lower need to perform the avoidance assistance control than a target that is other than a vehicle. Specifically, the stopped vehicle has a possibility to move in the aspect in which there is not a possibility to collide with the host vehicle, before the host vehicle passes it. As a result, it may be no longer necessary to perform the avoidance assistance control, or the assistance amount of the avoidance assistance control may be small. On the other hand, it is hard to predict a future movement of the target that is other than a vehicle, and it is thus hard to determine that there is a low need to perform the avoidance assistance control. Thus, if it is determined that, the target is the stopped vehicle, it is possible to perform a more appropriate avoidance assistance control by reducing the assistance amount associated with the avoidance assistance control, in comparison with those when it is determined that the target is other than a vehicle.

(Supplementary Note 4)

In a driving assistance apparatus described in Supplementary Note 4, if it is determined by the second determinator that the target is the stopped vehicle, the controller is programmed to control the executor to delay start timing of the avoidance assistance control, which is the control aspect, in comparison with than those when it is determined by the second determinator that the target is the parked vehicle.

As explained above, it can be determined that the stopped vehicle has a lower need to perform the avoidance assistance control than the parked vehicle. Thus, if it is determined that the target is the stopped vehicle, it is possible to perform a more appropriate avoidance assistance control by delaying the start tuning of the avoidance assistance control, in comparison with those when it is determined that the target is the parked vehicle. The expression “to delay” herein may include a control in which the start timing is delayed at the maximum and the avoidance assistance control is consequently not performed.

(Supplementary Note 6)

In a driving assistance apparatus described in Supplementary Note 5, if it is determined by the second determinator that the target is the stopped vehicle, the controller is programmed to control the executor to delay the start timing of the avoidance assistance control, in comparison with those when it is determined by the first determinator that the target is not a vehicle.

As explained above, it can be determined that the stopped vehicle has a lower need to perform the avoidance assistance control than the target that is other than a vehicle. Thus, if it is determined that the target is the stopped vehicle, it is possible to perform a more appropriate avoidance assistance control by delaying the start timing of the avoidance assistance control, in comparison with those when it is determined that the target is other than a vehicle.

The present disclosure may be embodied in other specific forms without departing from the spirit characteristics thereof. The present embodiments and examples are therefore to be considered in ail respects as illustrative and not restrictive, the scope of the disclosure being indicated by the appended claims rather than by the foregoing description and all changes which come in the meaning and range of equivalency of the claims are therefore intended to be embraced therein. What is claimed is:

1. A driving assistance apparatus comprising:
an executor configured to perform at least one of a deceleration control and a steering control of a host vehicle, as an avoidance assistance control for avoiding a contact between the host vehicle and a target, which is ahead of the host vehicle;
a first determinator configured to determine whether or not the target is a vehicle;
a second determinator configured to determine whether the target is (i) a stopped vehicle, which has a possibility to move before the host vehicle passes it, or (ii) a parked vehicle, which does not have a possibility to move before the host vehicle passes it, if it is determined by said first determinator that the target is a vehicle; and
a controller programmed to control said executor such that a control aspect of the avoidance assistance control is different between if it is determined by said second determinator that the target is the stopped vehicle and if it is determined by said second determinator that the target is the parked vehicle.

2. The driving assistance apparatus according to claim 1, wherein if it is determined by said second determinator that the target is the stopped vehicle, said controller is programmed to control said executor to reduce an assistance amount associated with the avoidance assistance control, which is the control aspect, in comparison with those when it is determined by said second determinator that the target is the parked vehicle.

3. The driving assistance apparatus according to claim 2, wherein if it is determined by said second determinator that the target is the stopped vehicle, said controller is programmed to control said executor to reduce the assistance amount associated with the avoidance assistance control, in comparison with those when it is determined by said first determinator that the target is not a vehicle.

4. The driving assistance apparatus according to claim 1, wherein if it is determined by said second determinator that the target is the stopped vehicle, said controller is programmed to control said executor to delay start timing of the avoidance assistance control, which is the control aspect, in comparison with than those when it is determined by said second determinator that the target is the parked vehicle.

5. The driving assistance apparatus according to claim 4, wherein if it is determined by said second determinator that the target is the stopped vehicle, said controller is programmed to control said executor to delay the start timing of the avoidance assistance control, in comparison with those when it is determined by said first determinator that the target is not a vehicle.
